(19) United States
(12) Patent Application Publication
(10) Pub. No.: US 2010/0208827 A1
(43) Pub. Date: Aug. 19, 2010

(54) METHODS AND APPARATUS FOR VIDEO ENCODING AND DECODING GEOMETERICALLY PARTITIONED SUPER MACROBLOCKS

(75) Inventors: Oscar Divorra Escoda, Barcelona (ES); Peng Yin, West Windsor, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Princeton, NJ (US)

(21) Appl. No.: 12/734,151

(22) PCT Filed: Oct. 15, 2008
(86) PCT No.: PCT/US2008/011756

§ 371 Date: Apr. 14, 2010

Related U.S. Application Data
(60) Provisional application No. 60/980,297, filed on Oct. 16, 2007.

(51) Int. Cl. H04N 7/30

(52) U.S. Cl. 375/240.24; 375/E07.226

(57) ABSTRACT

There are provided methods and apparatus for video encoding and decoding geometrically partitioned super blocks. An apparatus includes an encoder for encoding image data for at least a portion of a picture. The image data is formed by a geometric partitioning that applies geometric partitions to picture block partitions. The picture block partitions are obtained from at least one of top-down partitioning and bottom-up tree joining.

### CROSS-REFERENCE TO RELATED APPLICATIONS

This application claims the benefit of U.S. Provisional Application Ser. No. 60/980,297, filed Oct. 16, 2007, and which is incorporated by reference herein in its entirety.

### TECHNICAL FIELD

The present principles relate generally to video encoding and decoding and, more particularly, to methods and apparatus for video encoding and decoding geometrically partitioned super blocks.

### BACKGROUND

Tree-structured macroblock partitioning has been adopted in some of the current video coding standards. The International Telecommunication Union, Telecommunication Sector (ITU-T) H.261 Recommendation (hereinafter the “H.261 Recommendation”), the International Organization for Standardization/International Electrotechnical Commission (ISO/IEC) Moving Picture Experts Group-1 Standard (hereinafter the “MPEG-1 Standard), and the ISO/IEC Moving Picture Experts Group-2 Standard/ITU-T H.262 Recommendation (hereinafter the “MPEG-2 Standard”) support only 16×16 macroblock (MB) partitions. The ISO/IEC Moving Picture Experts Group-4 Part 2 simple profile or ITU-T H.263(+) Recommendation support both 16×16 and 8×8 partitions for a 16×16 macroblock. The ISO/IEC Moving Picture Experts Group-4 Part 10 Advanced Video Coding Standard/ITU-T H.264 Recommendation (hereinafter the “MPEG-4 AVC Standard”) supports tree-structured hierarchical macroblock partitions. A 16×16 macroblock can be partitioned into macroblock partitions of sizes 16×8, 8×16, or 8×8. 8×8 partitions are also known as sub-macroblocks. Sub-macroblocks can be further broken into sub-macroblock partitions of sizes 8×4, 4×8, and 4×4.

Depending on whether predictive (P) frames or bi-predictive (B) frames are encoded, different prediction configurations are possible using the tree-based partitions. These prediction configurations define the available coding modes in the MPEG-4 AVC Standard encoder and/or decoder. P frames allow for forward temporal prediction from a first list of reference frames, while B frames allow the use of up to two lists of reference frames, for backward/forward/bi-predictional prediction in block partitions. For instance, examples of these coding modes for P and B frames include the following:

### P-Frame:

$$MODE ∈ \{ \begin{matrix}INTRA 4 \times 4 , INTRA 16 \times 16 , INTRA 8 \times 8 , SKIP , \\ INTER 16 \times 16 , INTER 16 \times 8 , INTER 8 \times 16 , \\ INTER 8 \times 8 , INTER 8 \times 4 , INTER 4 \times 8 , INTER 4 \times 4\end{matrix} \} ,$$

### B-Frame:

$$MODE ∈ \{ \begin{matrix}INTRA 4 \times 4 , INTRA 16 \times 16 , INTRA 8 \times 8 , \\ BIDIRECT , DIRECT , \\ FWD 16 \times 16 , BKW 16 \times 16 , BI 16 \times 16 \\ FWD - FWD 16 \times 8 , FWD - BKW 16 \times 8 , \\ BKW - FWD 16 \times 8 , BKW - BKW 16 \times 8 \\ FWD - BI 16 \times 8 , BI - FWD 16 \times 8 , \\ BKW - BI 16 \times 8 , BI - BKW 16 \times 8 , BI - BI 16 \times 8 \\ FWD - FWD 8 \times 16 , FWD - BKW 8 \times 16 , \\ BKW - FWD 16 \times 8 , BKW - BKW 16 \times 8 \\ FWD - BI 16 \times 8 , BI - FWD 16 \times 8 , \\ BKW - BI 16 \times 8 , BI - BKW 16 \times 8 , BI - BI 16 \times 8 \\ 8 \times 8 , etc …\end{matrix} \} ,$$

where “FWD” indicates prediction from the forward prediction list, “BKW” indicates prediction from the backward prediction list, “BI” indicates bi-prediction from both the forward and backward lists, “FWD-FWD indicates two predictions each from the forward prediction list, and “FWD-BKW” indicates a first prediction from the forward prediction list and a second prediction from the backward prediction list.

Also, intra frames allow for prediction coding modes at 16×16, 8×8 and/or 4×4 blocks, with the corresponding macroblock coding modes: INTRA4×4; INTRA16×16; and INTRA8×8.

The frame partition in the MPEG-4 AVC Standard is more efficient than the simple uniform block partition typically used in older video coding standards such as the MPEG-2 Standard. However, tree based frame partitioning is not without deficiency, as it is inefficient in some coding scenarios due to its inability to capture the geometric structure of two-dimensional (2D) data. In order to solve such limitations, a prior art method (hereinafter “prior art method”) was introduced to better represent and code two-dimensional video data by taking its two-dimensional geometry into account. The prior art method utilizes wedge partitions (i.e., partition of a block into two regions that are separated by an arbitrary line or curve) in a new set of modes for both inter (INTER16×16GEO, INTER8×8GEO) and intra prediction (INTRA16×16GEO, INTRA8×8GEO).

In one implementation of the prior art method, the MPEG-4 AVC Standard is used as a basis to incorporate the geometric partition mode. Geometric partitions within blocks are modeled by the implicit formulation of a line. Turning to FIG. 1, an exemplary geometric partitioning of an image block is indicated generally by the reference numeral 100. The overall image block is indicated generally by the reference numeral 120, and the two partitions of the image block 120, locating on opposing sides of diagonal line 150, are respectively indicated generally by the reference numerals 130 and 140.

Hence, partitions are defined as follows:

f(x,y)=x cos θ+y sin θ−ρ,

where ρ, θ respectively denote the following: the distance from the origin to the boundary line f(x,y) in the orthogonal direction to f(x,y); and the angle of the orthogonal direction to f(x,y) with the horizontal coordinate axis x.

It directly follows from its formulation that more involved models for f(x,y) with higher order geometric parameters are also considered.

Each block pixel (x,y) is classified such that:

$$GEO\_Partition = \{ \begin{matrix}if f ( x , y ) > 0 & Partition 0 \\ if f ( x , y ) = 0 & Line Boundary \\ if f ( x , y ) < 0 & Partition 1\end{matrix}$$

For coding purposes, a dictionary of possible partitions (or geometric modes) is a priori defined. This can be formally defined such that:

$$\begin{matrix}\begin{matrix}ρ : ρ ∈ [ 0 , \frac{\sqrt{2} {MB}_{Size}}{2} ) and ρ ⋐ \{ 0 , Δρ , 2 \cdot Δρ , 3 \cdot Δρ , … \} , \\ and\end{matrix} \\ θ : \{ \begin{matrix}if ρ = 0 & θ ∈ [ 0 , 180 ) \\ else & θ ∈ [ 0 , 360 )\end{matrix} and θ ⋐ \{ 0 , Δθ , 2 \cdot Δθ , 3 \cdot Δθ , … \} ,\end{matrix}$$

where Δρ and Δθ are the selected quantization (parameter resolution) steps. The quantized indices for θ and ρ are the information transmitted to code the edge. However, if modes 16×8 and 8×16 are used in the coding procedure, angles 0 and 90, for the case of ρ=0, can be removed from the set of possible edges.

Within the prior art method, for a geometry-adaptive motion compensation mode, a search on θ and ρ, and motion vectors for each partition is performed in order to find the best configuration. A full search strategy is done in two stages, for every θ and ρ pair, where the best motion vectors are searched. Within the geometry-adaptive intra prediction mode, a search on θ and ρ and the best predictor (directional prediction or statistics, and so forth) for each partition is performed in order to find the best configuration.

Turning to FIG. 2, an exemplary INTER-P image block partitioned with a geometry adaptive straight line is indicated generally by the reference numeral 200. The overall image block is indicated generally by the reference numeral 220, and the two partitions of the image block 220 are respectively indicated generally by the reference numerals 230 and 240.

The prediction compensation of the block can be stated as follows for P modes:

Î=Î_{t′}(\vec{x}−MV₁)·MASK_{P0}(x,y)+Î_{t″}(\vec{x}−MV₂)·MASK_{P1}(x,y),

where Ît represents the current prediction and Î_{t′}(\vec{x}−MV₂) and Î_{t″}(\vec{x}−MV₁) are the block motion compensated references for partitions P2 and P1, respectively. Each MASK_{P}(x,y) includes the contribution weight for each pixel (x,y) for each of the partitions. Pixels that are not on the partition boundary generally do not need any operation. In practice, the mask value is either 1 or 0. Only those pixels near the partition border may need to combine the prediction values from both references.

Thus, video and image coding using geometry-adaptive block partitioning has been identified as a promising direction for improving video coding efficiency. Geometry-adaptive block partitioning allows for more accurate picture predictions, where local prediction models such as inter and/or intra predictors can be tailored according to the structure of pictures. However, the coding gain for High Definition (HD) video and images still needs to improved.

For example, geometry-adaptive block partitioning in inter frames prediction shows a great coding efficiency improvement for low-to-medium resolution video content. As an example, geometrically partitioned blocks are particularly good at improving the prediction of blocks where a motion edge exists. However, for high definition video content, the gain achieved by geometric modes is limited and does not balance the complexity that geometric modes require. One possible reason is that high definition content has larger signal structures, while the macroblock (MB) size used in existing video coding standards is fixed to 16×16 size (which does not scale well to the increased object sizes of high definition).

Geometry-adaptive partitioning of macroblocks is thus not able to make a great difference in high definition coding, at least for a great deal of the type of high definition content that is encoded. Indeed, it is not able to compact enough information compared to the much larger area of the signal. For example, the coding gain introduced by every geometrically partitioned inter block is averaged out by the much higher amount of blocks with “uniform” motion, since from a rate-distortion point of view, only a small percentage of the blocks will have a reduced R-D cost.

### Enlarged Block Sizes for HD Video Coding

Different research efforts have been conducted on high definition content compression in order to overcome the limitations of the MPEG-4 AVC Standard. A clear example of this is the studies on increasing macroblock size. There have been results on the benefit of allowing macroblock sizes larger than 16×16. Extended partition block modes such as 32×32, 32×16 and 16×32 have been used to complement a MPEG-4 AVC Standard video codec. Efficiency results directed to the use of such extended partition block modes indicated a relatively large gain can be achieved when using enlarged macroblocks sizes.

Thus far, research related to the use of enlarged block sizes only incorporates simple uniform quad-tree partitions. Quad-tree partitioning presents the same limitations for high definition content as for lower resolution content. Quad-tree partitioning is unable to capture the geometric structure of two-dimensional (2D) video and/or image data.

### SUMMARY

These and other drawbacks and disadvantages of the prior art are addressed by the present principles, which are directed to methods and apparatus for video encoding and decoding geometrically partitioned super blocks.

According to an aspect of the present principles, there is provided an apparatus. The apparatus includes an encoder for encoding image data for at least a portion of a picture. The image data is formed by a geometric partitioning that applies geometric partitions to picture block partitions. The picture block partitions are obtained from at least one of top-down partitioning and bottom-up tree joining.

According to another aspect of the present principles, there is provided a method. The method includes encoding image data for at least a portion of a picture. The image data is formed by a geometric partitioning that applies geometric partitions to picture block partitions. The picture block partitions are obtained from at least one of top-down partitioning and bottom-up tree joining.

According to yet another aspect of the present principles, there is provided an apparatus. The apparatus includes a decoder for decoding image data for at least a portion of a picture. The image data is formed by a geometric partitioning that applies geometric partitions to picture block partitions. The picture block partitions are obtained from at least one of top-down partitioning and bottom-up tree joining.

According to still another aspect of the present principles, there is provided a method. The method includes decoding image data for at least a portion of a picture. The image data is formed by a geometric partitioning that applies geometric partitions to picture block partitions. The picture block partitions are obtained from at least one of top-down partitioning and bottom-up tree joining.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram for an exemplary geometric partitioning of an image block;

FIG. 2 is a diagram for an exemplary INTER-P image block partitioned with a geometry adaptive straight line;

FIG. 3 is a block diagram for an exemplary encoder to which the present principles may be applied, in accordance with an embodiment of the present principles;

FIG. 4 is a block diagram for an exemplary decoder to which the present principles may be applied, in accordance with an embodiment of the present principles;

FIG. 5A is a diagram for an exemplary combined super block and sub-block tree-based frame partitioning using a bottom-up and top-down approach that results in multiple macroblocks, in accordance with an embodiment of the present principles;

FIG. 5B is a diagram for exemplary super blocks and sub-blocks formed from the tree-based partitioning 500 of FIG. 5A, in accordance with an embodiment of the present principles;

FIG. 6 is a diagram for exemplary super blocks formed from unions of macroblocks, in accordance with an embodiment of the present principles;

FIG. 7 is a diagram for an exemplary approach for managing deblocking areas of a super block, in accordance with an embodiment of the present principles;

FIG. 8 is a diagram for another exemplary approach for managing deblocking areas of a super block, in accordance with an embodiment of the present principles;

FIG. 9 is a diagram for an example of a raster scan ordering in accordance with the MPEG-4 AVC Standard and an example of zig-zag scan ordering in accordance with an embodiment of the present principles;

FIG. 10 is a diagram for an exemplary partition of a picture, in accordance with an embodiment of the present principles;

FIG. 11 is a flow diagram for an exemplary method for video encoding, in accordance with an embodiment of the present principles; and

FIG. 12 is a flow diagram for an exemplary method for video decoding, in accordance with an embodiment of the present principles.

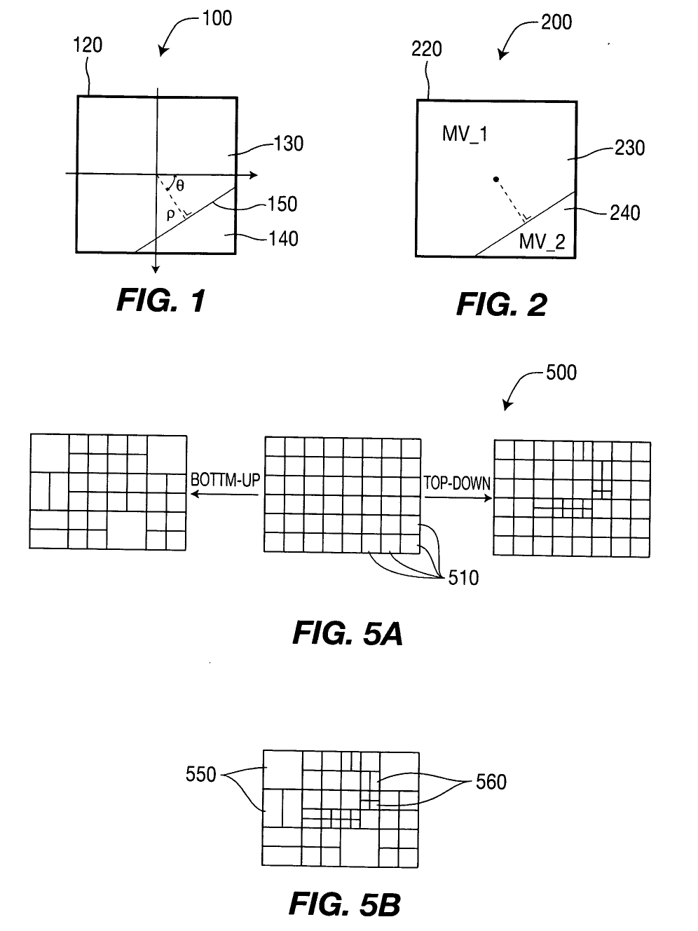

### DETAILED DESCRIPTION

The present principles are directed to methods and apparatus for video encoding and decoding geometrically partitioned super blocks.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment. Moreover, the phrase “in another embodiment” does not exclude the subject matter of the described embodiment from being combined, in whole or in part, with another embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

Additionally, as used herein, the phrase “super block” refers to, for example, a block having a block size larger than 8 in the MPEG-2 Standard and a block size larger than 4 in the MPEG-4 AVC Standard. Of course, it is to be appreciated that the present principles are not limited solely to these standards and, thus, one of ordinary skill in this and related arts would understand and readily ascertain the different block sizes that may be implicated for super blocks with respect to other video coding standards and recommendations given the teachings of the present principles provided herein.

Moreover, as used herein, the phrase “base partitioning size” generally refers to a macroblock as defined in the MPEG-4 AVC standard. Of course, as noted above, the present principles are not limited to solely the MPEG-4 AVC Standard, and, thus, “base partitioning size” may be different in other coding standards and recommendations, as is readily apparent to one of ordinary skill in this and related arts, while maintaining the spirit of the present principles.

Further, it is to be appreciated that deblocking filtering as described herein may be performed in-loop or outside the encoding and/or decoding loops, while maintaining the spirit of the present principles.

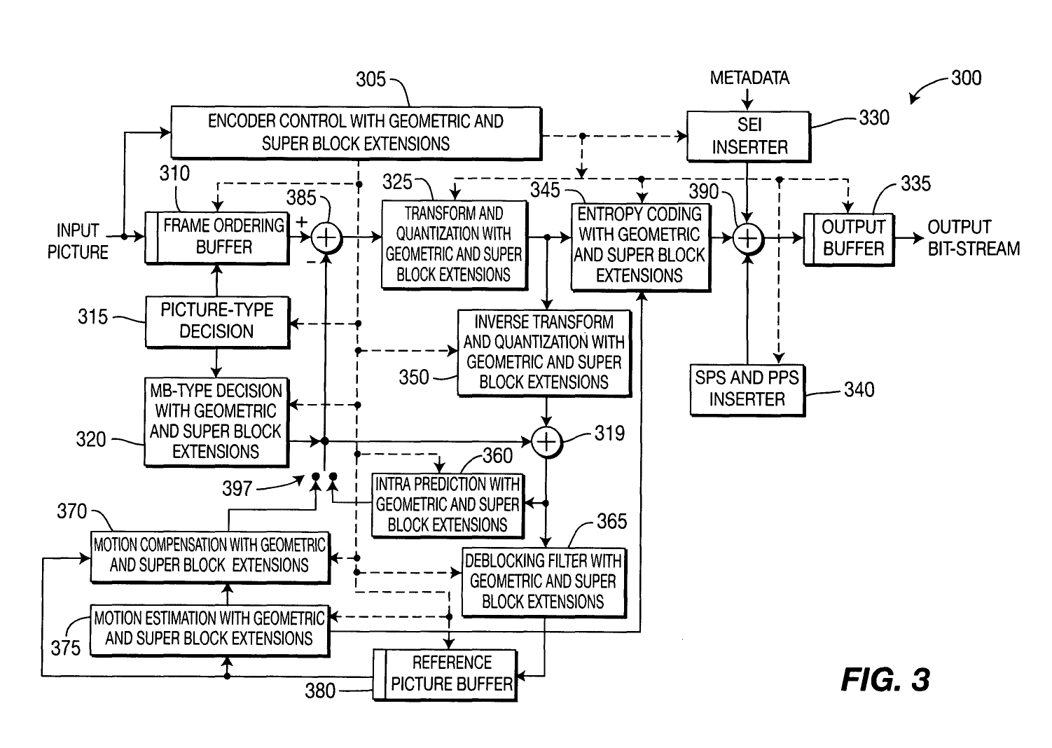

Turning to FIG. 3, a video encoder capable of performing video encoding in accordance with the MPEG-4 AVC standard is indicated generally by the reference numeral 300.

The video encoder 300 includes a frame ordering buffer 310 having an output in signal communication with a non-inverting input of a combiner 385. An output of the combiner 385 is connected in signal communication with a first input of a transformer and quantizer with geometric and super block extensions 325. An output of the transformer and quantizer with geometric and super block extensions 325 is connected in signal communication with a first input of an entropy coder with geometric and super block extensions 345 and a first input of an inverse transformer and inverse quantizer with geometric extensions 350. An output of the entropy coder with geometric and super block extensions 345 is connected in signal communication with a first non-inverting input of a combiner 390. An output of the combiner 390 is connected in signal communication with a first input of an output buffer 335.

A first output of an encoder controller with geometric and super block extensions 305 is connected in signal communication with a second input of the frame ordering buffer 310, a second input of the inverse transformer and inverse quantizer with geometric and super block extensions 350, an input of a picture-type decision module 315, a first input of a macroblock-type (MB-type) decision module with geometric and super block extensions 320, a second input of an intra prediction module with geometric and super block extensions 360, a second input of a deblocking filter with geometric and super block extensions 365, a first input of a motion compensator with geometric and super block extensions 370, a first input of a motion estimator with geometric and super block extensions 375, and a second input of a reference picture buffer 380.

A second output of the encoder controller with geometric and super block extensions 305 is connected in signal communication with a first input of a Supplemental Enhancement Information (SEI) inserter 330, a second input of the transformer and quantizer with geometric and super block extensions 325, a second input of the entropy coder with geometric and super block extensions 345, a second input of the output buffer 335, and an input of the Sequence Parameter Set (SPS) and Picture Parameter Set (PPS) inserter 340.

An output of the SEI inserter 330 is connected in signal communication with a second non-inverting input of the combiner 390.

A first output of the picture-type decision module 315 is connected in signal communication with a third input of a frame ordering buffer 310. A second output of the picture-type decision module 315 is connected in signal communication with a second input of a macroblock-type decision module with geometric and super block extensions 320.

An output of the Sequence Parameter Set (SPS) and Picture Parameter Set (PPS) inserter 340 is connected in signal communication with a third non-inverting input of the combiner 390.

An output of the inverse quantizer and inverse transformer with geometric and super block extensions 350 is connected in signal communication with a first non-inverting input of a combiner 319. An output of the combiner 319 is connected in signal communication with a first input of the intra prediction module with geometric and super block extensions 360 and a first input of the deblocking filter with geometric and super block extensions 365. An output of the deblocking filter with geometric and super block extensions 365 is connected in signal communication with a first input of a reference picture buffer 380. An output of the reference picture buffer 380 is connected in signal communication with a second input of the motion estimator with geometric and super block extensions 375 and with a third input of the motion compensator with geometric and super block extensions 370. A first output of the motion estimator with geometric and super block extensions 375 is connected in signal communication with a second input of the motion compensator with geometric and super block extensions 370. A second output of the motion estimator with geometric and super block extensions 375 is connected in signal communication with a third input of the entropy coder with geometric and super block extensions 345.

An output of the motion compensator with geometric and super block extensions 370 is connected in signal communication with a first input of a switch 397. An output of the intra prediction module with geometric and super block extensions 360 is connected in signal communication with a second input of the switch 397. An output of the macroblock-type decision module with geometric and super block extensions 320 is connected in signal communication with a third input of the switch 397. The third input of the switch 397 determines whether or not the “data” input of the switch (as compared to the control input, i.e., the third input) is to be provided by the motion compensator with geometric and super block extensions 370 or the intra prediction module with geometric and super block extensions 360. The output of the switch 397 is connected in signal communication with a second non-inverting input of the combiner 319 and with an inverting input of the combiner 385.

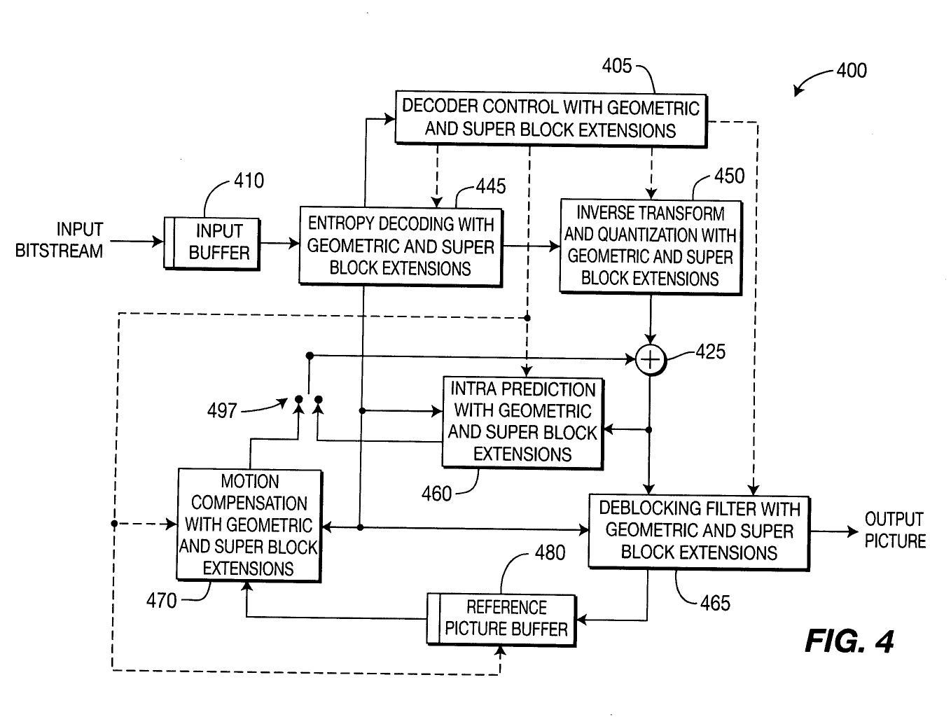

A first input of the frame ordering buffer 310 and an input of the encoder controller with geometric and super block extensions 305 are available as input of the encoder 100, for receiving an input picture. Moreover, a second input of the Supplemental Enhancement Information (SEI) inserter 330 is available as an input of the encoder 300, for receiving metadata. An output of the output buffer 335 is available as an output of the encoder 300, for outputting a bitstream. Turning to FIG. 4, a video decoder capable of performing video decoding in accordance with the MPEG-4 AVC standard is indicated generally by the reference numeral 400.

The video decoder 400 includes an input buffer 410 having an output connected in signal communication with a first input of the entropy decoder with geometric and super block extensions 445. A first output of the entropy decoder with geometric and super block extensions 445 is connected in signal communication with a first input of an inverse transformer and inverse quantizer with geometric and super block extensions 450. An output of the inverse transformer and inverse quantizer with geometric and super block extensions 450 is connected in signal communication with a second non-inverting input of a combiner 425. An output of the combiner 425 is connected in signal communication with a second input of a deblocking filter with geometric and super block extensions 465 and a first input of an intra prediction module with geometric and super block extensions 460. A second output of the deblocking filter with geometric and super block extensions 465 is connected in signal communication with a first input of a reference picture buffer 480. An output of the reference picture buffer 480 is connected in signal communication with a second input of a motion compensator with geometric and super block extensions 470.

A second output of the entropy decoder with geometric and super block extensions 445 is connected in signal communication with a third input of the motion compensator with geometric and super block extensions 470 and a first input of the deblocking filter with geometric and super block extensions 465. A third output of the entropy decoder with geometric and super block extensions 445 is connected in signal communication with an input of a decoder controller with geometric and super block extensions 405. A first output of the decoder controller with geometric and super block extensions 405 is connected in signal communication with a second input of the entropy decoder with geometric and super block extensions 445. A second output of the decoder controller with geometric and super block extensions 405 is connected in signal communication with a second input of the inverse transformer and inverse quantizer with geometric and super block extensions 450. A third output of the decoder controller with geometric and super block extensions 405 is connected in signal communication with a third input of the deblocking filter with geometric and super block extensions 465. A fourth output of the decoder controller with geometric extensions 405 is connected in signal communication with a second input of the intra prediction module with geometric extensions 460, with a first input of the motion compensator with geometric and super block extensions 470, and with a second input of the reference picture buffer 480.

An output of the motion compensator with geometric and super block extensions 470 is connected in signal communication with a first input of a switch 497. An output of the intra prediction module with geometric and super block extensions 460 is connected in signal communication with a second input of the switch 497. An output of the switch 497 is connected in signal communication with a first non-inverting input of the combiner 425.

An input of the input buffer 410 is available as an input of the decoder 400, for receiving an input bitstream. A first output of the deblocking filter with geometric extensions 465 is available as an output of the decoder 400, for outputting an output picture.

As noted above, the present principles are directed to methods and apparatus for video encoding and decoding geometrically partitioned super blocks.

In an embodiment, we propose a new geometry-adaptive partitioning framework based on the partitioning of larger block sizes or super blocks. In particular, this can improve coding efficiency for high definition (HD) video content, by providing block partitions better adapted to exploit the redundancy in pictures with content of a larger format size, thus reducing the loss in performance of geometrically partitioned blocks as content resolution increases.

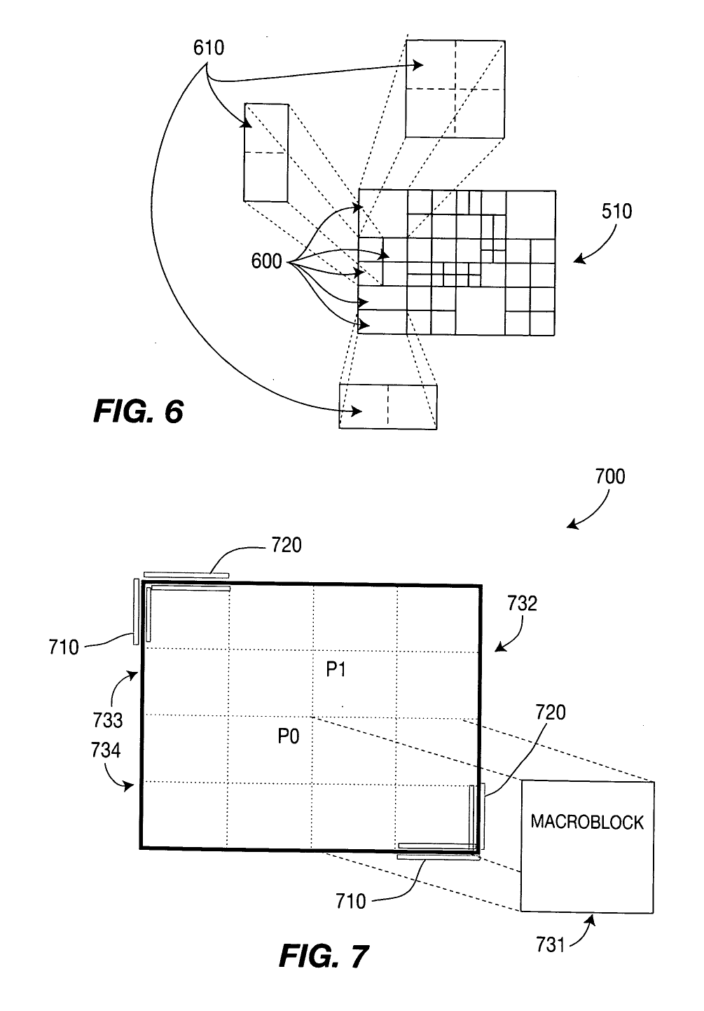

In an embodiment, geometric partitioning is introduced at super-macroblock size (see, e.g., FIGS. 5A, 5B, and 6), such as 32×32, 64×64, and so forth.

Turning to FIG. 5A, an exemplary combined super block and sub-block tree-based frame partitioning using a bottom-up and top-down approach that results in multiple macroblocks is indicated generally by the reference numeral 500. The macroblocks are indicated generally by the reference numeral 510. Turning to FIG. 5B, exemplary super blocks and sub-blocks formed from the tree-based partitioning 500 of FIG. 5A respectively are indicated generally by the reference numerals 550 and 560. Turning to FIG. 6, exemplary super blocks are indicated generally by the reference numeral 600. The super blocks 600 are formed from unions of macroblocks 510. Upper left macroblocks (within the super blocks 600) are indicated generally by the reference numeral 610.

Super-macroblock geometric partitioning can be used independently (i.e., on its own), or may be combined with the use of other simple partitionings of a super-macroblock based on quad-tree partitioning. For example, in an embodiment, one can use Inter32×32GEO, Inter32×32, Inter32×16 and Inter16×32 modes, together with the rest of the regular MPEG-4 AVC Standard coding modes for inter prediction. It is to be appreciated that the preceding partition sizes and coding modes are merely illustrative and, thus, given the teachings of the present principles provided herein, one of ordinary skill in this and related arts will contemplate these and various other partition sizes and coding modes, as well as other variations with respect to encoding and decoding, while maintaining the spirit of the present principles. Thus, for example, one of ordinary skill in this and related arts would readily recognize that similar approaches to generalize intra coding modes using geometric partitioning for larger content sizes clearly fall within the spirit of the present principles.

Thus, while one or more embodiments described herein are so described with respect to a particular super block size of 32×32, and with respect to the MPEG-4 AVC Standard, the present principles are not limited to the same and may be used with respect to other super block sizes and other video coding standards, recommendations, and extensions thereof, while maintaining the spirit of the present principles.

Thus, in one embodiment, we add a new super block mode:

INTER32×32GEO, in addition to the modes shown in TABLE 1.

TABLE 1

| Macroblock Modes: | Sub-Macroblock Modes: |
|---|---|
| SKIP/DIRECT16×16 | DIRECT8×8 (InterB) |
| INTER16×16 | INTER8×8 |
| INTER16×8 | INTER8×4 |
| INTER8×16 | INTER4×8 |
| INTER16×16GEO | INTER8×8GEO |
| INTER8×8Sub | INTER4×4 |

For INTER32×32GEO, like in smaller size geometrically partitioned blocks, one needs to send the necessary information to describe the partition edge. In an embodiment, the partitioning edge can be determined by a pair of parameters (θ and ρ). For each partition, the appropriate predictor is encoded. That is, for P-Frames, two motion vectors are encoded (one for each partition of the super block). For B-Frames, the prediction mode for each partition, such as forward prediction, backward prediction or bi-prediction, is encoded. This information can be separately or jointly coded with the coding mode. In the B-Frames case, and depending on the prediction mode to be used in every geometric partition, one motion vector (from one of the prediction lists) or two motion vectors are encoded along with the rest of information of the coded block. We should note that edge information and/or motion information can be encoded by explicitly sending the related information or by implicitly deriving it at the encoder/decoder. Indeed, in an embodiment, implicit derivation rules can be defined such that edge information of a given block is derived from available data already encoded/decoded, and/or motion information of at least one of the partitions is derived from available data already encoded/decoded.

Efficient explicit coding of motion in formation requires the use of motion prediction based on a prediction model using the available data already encoded/decoded. In the case of motion vector prediction for geometrically partitioned coding modes on a super-macroblock, a similar approach to INTER16×16GEO can be used. That is, motion vectors in partitions are predicted from the available 4×4 sub-block motion neighbors of each partition, and for each list depending on the shape of the partition. Given a neighboring 4×4 sub-block that is crossed by an edge partition, the motion vector considered is the one from the partition that has the biggest overlap with the 4×4 sub-block.

### Residual Coding

The residual signal remaining after prediction using a geometrically partitioned block mode is transformed, quantized and entropy encoded. In the framework of the MPEG-4 AVC Standard, one can select transforms of size 8×8 and 4×4 at every encoded macroblock. The same can be applied to geometrically partitioned super-macroblocks. However, in an embodiment, one can incorporate the possibility of using bigger transforms in order to better handle smoother residuals achieved with the more efficient geometry-adaptive coding modes in super-macroblocks. One can allow for the possibility of selecting the size of the transform for at least one of every super-macroblock, every macroblock partition within a super-macroblock, and a sub-macroblock partition within macroblock partitions within a super-macroblock. In an embodiment, possible transforms for the selections are 4×4, 8×8, and 16×16. Eventually, in another embodiment, one could even consider 32×32 transforms. In another example, we can reuse the existing syntax in the MPEG-4 AVC Standard which supports 4×4 and 8×8 transforms. However, we can change the set of possible transforms to 8×8 and 16×16 transforms, instead of 4×4 and 8×8 transforms, i.e., by changing the semantics of syntax. To be specific, in the MPEG-4 AVC Standard, the following syntax semantics are set forth:

transform_size_{—}8×8_flag equal to 1 specifies that for the current macroblock the transform coefficient decoding process and picture construction process prior to the deblocking filter process for residual 8×8 blocks shall be invoked for luma samples. transform_size_{—}8×8_flag equal to 0 specifies that for the current macroblock the transform coefficient decoding process and picture construction process prior to the deblocking filter process for residual 4×4 blocks shall be invoked for luma samples. When transform_size_{—}8×8_flag is not present in the bitstream, it shall be inferred to be equal to 0.

We can change the semantics as follows:

transform_size_{—}8×8_flag equal to 1 specifies that for the current macroblock the transform coefficient decoding process and picture construction process prior to the deblocking filter process for residual 8×8 blocks shall be invoked for luma samples. transform_size_{—}8×8_flag equal to 0 specifies that for the current macroblock the transform coefficient decoding process and picture construction process prior to deblocking filter process for residual 16×16 blocks shall be invoked for luma samples. When transform_size_{—}8×8_flag is not present in the bitstream, it shall be inferred to be equal to 1.

### Deblocking Filtering

In-loop de-blocking filtering reduces blocking artifacts introduced by the block structure of the prediction as well as by the residual coding MPEG-4 AVC Standard transform. In-loop de-blocking filtering adapts the filtering strength based on the encoded video data as well as local intensity differences between pixels across block boundaries. In an embodiment, where super-macroblocks are geometrically partitioned, one can have INTER32×32GEO coding modes (i.e., geometric partition of the union of four 16×16 macroblocks), where different transform sizes may be used to code the residual signal. In an embodiment, deblocking filtering is adapted for use in geometrically partitioned super-macroblocks. Indeed, instead of macroblock boundaries, super-macroblock boundaries are considered to be locations with a potential for presenting blocky artifacts. At the same time, transform boundaries are locations where blocking artifacts may appear. Hence, if larger size transforms (such as 16×16 transforms) are used, 16×16 block transform boundaries may present blocking artifacts, instead of all 4×4 and/or 8×8 block boundaries

In an exemplary embodiment, the in-loop deblocking filter module is extended by adapting the process of the filter strength decision for INTER32×32GEO and other modes. This process should now be able to decide the filter strength taking into account the particular shape of internal super block partitions. Depending on the part of the super block boundary to filter, the process of the filter strength decision obtains the appropriate motion vector and reference frame according to the partition shape (as illustrated in FIG. 7), and not according to 4×4 blocks, as done by other MPEG-4 AVC modes. Turning to FIG. 7, an exemplary approach for managing deblocking areas of a super block is indicated generally by the reference numeral 700. Deblocking strength computed with motion vector MV_{P0} and reference frames from P0 is indicated generally by the reference numeral 710. Deblocking strength computer with motion vector MV_{P1} and reference frames from P1 is indicated generally by the reference numeral 720. The super block 730 is formed from four macroblocks 731, 732, 733, 734 using a geometric partition (INTER32×32GEO mode).

Prediction information (e.g., motion vectors, reference frame, and/or so forth) is taken into account in setting the deblocking strength on a particular picture location. Given a location, prediction information is extracted by choosing the partition that overlaps the most with the transform block side to be filtered. However, a second alternative method, that simplifies computation in corner blocks, involves considering the whole transform block to have the motion and reference frame information from the partition that includes the largest part of both block boundaries subject to filtering.

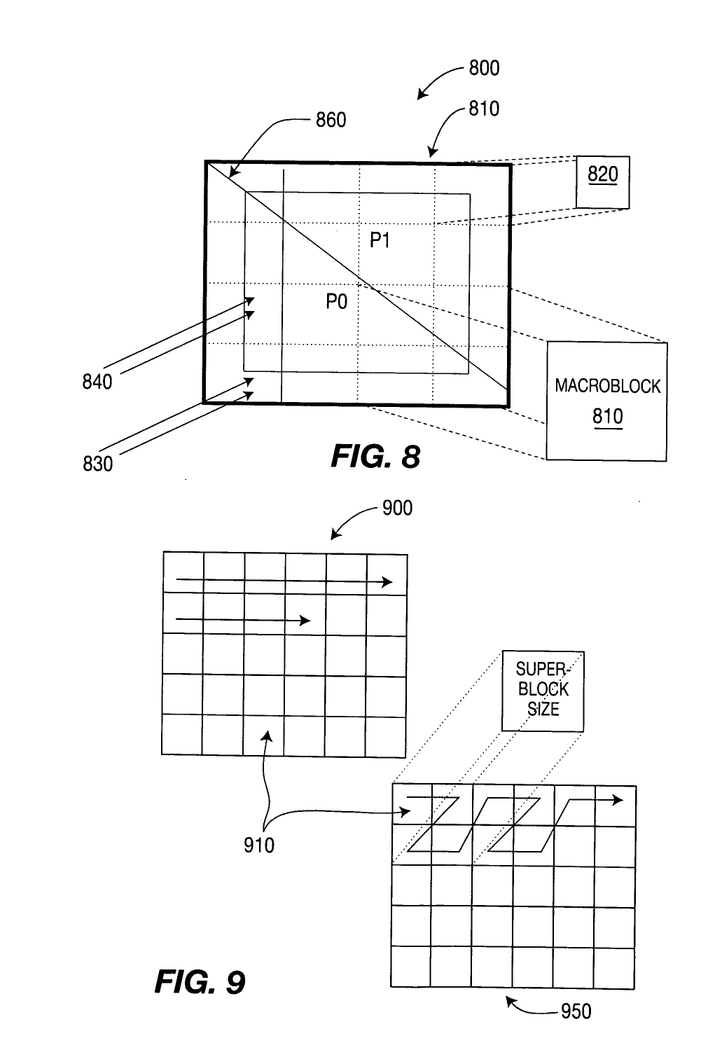

Another example of a method for combining deblocking in-loop filtering with the use of geometrically partitioned super block partitioning is to always allow some degree of filtering through super block boundaries for coding modes such as INTER32×32GEO and other modes. At the same time, deblocking filtering may or may not be applied to those transform blocks, in a super block geometric mode, that are not located on the boundary of a super-macroblock (see, e.g., FIG. 8). Turning to FIG. 8, another exemplary approach for managing deblocking areas of a super block is indicated generally by the reference numeral 800. The example of FIG. 8 relates to an INTER32×32GEO super-macroblock mode, showing the macroblocks 810 from which the super-macroblock 810 is formed, as well as the location of transform blocks 820 for the residual. Moreover, areas 830 and 840 correspond to a deblocking filtering strength equal to one and deblocking filtering strength equal to zero, respectively. The geometric boundary between prediction partitions is indicated by the reference numeral 860.

### Coding Mode Signaling

A geometrically partitioned super-macroblock coding mode requires a distinctive signaling with respect to other coding modes. In one example, the general use of INTER32×32GEO is enabled and/or disabled by adding a new high level syntax element (e.g., inter32×32geo_enable), which can be transmitted, for example, but not limited to, a slice level, a picture level, a sequence level, and/or in a Supplemental Enhancement Information (SEI) message. At the decoder, if inter32×32geo_enable is equal to one, then the use of geometrically partitioned super-macroblocks is enabled. Otherwise, if inter32×32geo_enable is equal to zero, then the use of geometrically partitioned super blocks is disabled.

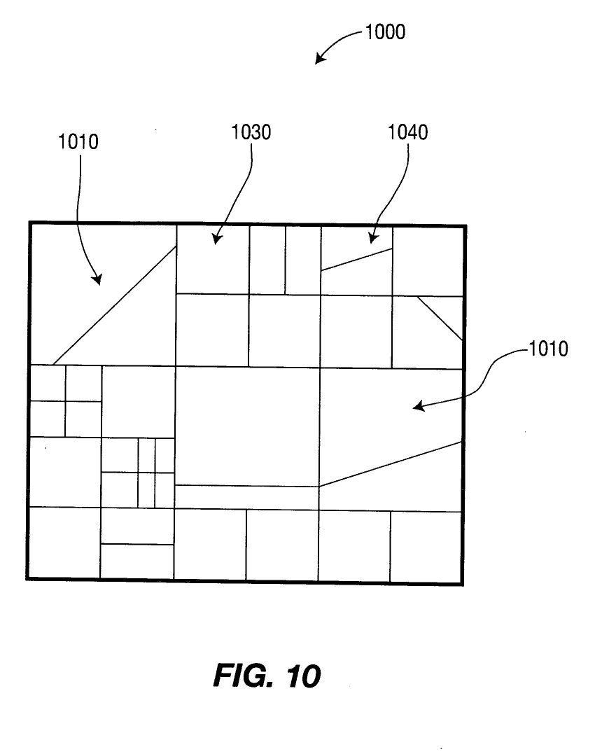

In an embodiment relating to the case when the use of super-macroblocks with geometric partitions is enabled, the scanning order through macroblocks is changed from simple raster-scan order to zig-zag order in order to better accommodate INTER32×32GEO super-macroblock modes. Turning to FIG. 9, an example of a raster scan ordering in accordance with the MPEG-4 AVC Standard and an example of zig-zag scan ordering in accordance with an embodiment of the present principles are respectively and generally indicated by the reference numerals 900 and 950, respectively. Macroblocks are indicated by the reference numeral 910. This change in scanning order, from raster scan order to zig-zag scan order, better accommodates the adaptive use of INTER32×32GEO (coding mode laying at a super-macroblock level) together with the regular INTER16×16GEO and other MPEG-4 AVC Standard coding modes (laying at a macroblock and sub-macroblock level). Turning to FIG. 10, an exemplary partition of a picture is indicated generally by the reference numeral 1000. With respect to the partition 1000, geometrically partitioned super-macroblocks (e.g., INTER32×32GEO) 1010 are used to encode unions of 16×16 macroblocks (e.g., INTER16×16 macroblocks 1030 and INTER16×16GEO macroblocks 1040) at the same time that some areas of the picture are encoded using a conventional macroblock structure. In FIG. 10, the blocks in the bottom row correspond to the conventional macroblock structure.

If inter32×32geo_enable is equal to zero, then only the modes listed in TABLE 1 will be considered for coding on a macroblock basis using raster scanning order.

Without loss of generality, many other names for inter32×32geo_flag can be considered and fall within the spirit of the present principles.

In order to communicate to the decoder when and where to use super-macroblock geometric partitions, additional information and/or syntax may be created, generated, and inserted within, for example, the slice data, in accordance with the present principles.

In an embodiment, despite super-macroblock partitioning being performed, the macroblock signaling structure is maintained. This allows us to re-use the already existing macroblock type coding modes such as those from the MPEG-4 AVC Standard as well as any coding modes for eventual extensions with geometry-adaptive block partitioning, where at least one of a INTER16×16GEO, INTER8×8GEO, INTRA16×16GEO and INTRA8×8GEO are added as selectable modes to the list of modes used by the MPEG-4 AVC Standard (e.g., see Table 1). This simplifies the construction of new codecs as parts of existing former codecs can be reused.

Given such a macroblock-based signaling framework and the change of macroblock scanning order (see FIG. 9), in an embodiment of this invention, one can signal that a geometrically partitioned super-macroblock is to be used in a given location of a slice and/or picture, by the addition of a flag at the macroblock level (e.g., inter32×32geo_flag). The use of this flag can be limited to macroblocks with Mode INTER16×16GEO. This allows for the re-use of such a mode coding structure to signal the introduced coding mode INTER32×32GEO, by simply signaling a one or a zero using this flag. Moreover, since super-macroblocks are structured hierarchically with respect to macroblock partitions and, in our example, a super-macroblock consists of a 2 by 2 macroblock, only macroblocks located at positions with (x,y) coordinates with x being an even number and y being an even number need to carry the inter32×32geo_flag flag. For this, let us assume that the upper left most macroblock in a slice is the (0,0) macroblock.

Based on this, if a macroblock with even-even (x,y) coordinates (e.g., (2,2)) is of INTER16×16GEO type and has inter32×32geo_flag set equal to one, then such a case indicates that macroblocks (2,2), (2,3), (3,2) and (3,3) are grouped within a super-macroblock with a geometric partition. In such a case, the syntax of macroblock (2,2) related to geometric information (such as angle or position for the geometric partition) can be re-used to transmit the geometric information of the super-macroblock. Eventually, in an embodiment, the resolution at which geometric parameters are coded can be changed depending on inter32×32geo_flag in order to achieve the best coding efficiency possible. The same applies for motion information and super-macroblock prediction. Following with this, since (2,2) macroblock contains all the necessary information to determine the coding mode and the prediction of the super-macroblock data, no mode information nor prediction information requires to be sent at macroblocks (2,3), (3,2), (3,3). In an embodiment of this invention, only the residual requires to be transmitted in such macroblocks. However, one skilled in the art would understand that the scheme can be modified such that the residual data is all transmitted within the macroblock data structure of macroblock (2,2), and still fall within the scope of the present invention. It is simply necessary to change the structure of residual coding at the macroblock level depending on inter32×32geo_flag. If inter32×32geo_flag is equal to 1, then a residual super block is encoded (i.e. 32×32 residual). Otherwise, if inter32×32geo_flag is equal to 0, then a single macroblock residual is encoded.

In an embodiment of this invention, depending on inter32×32geo_flag the size of the residual transform can be also modified, e.g. 8×8 or 16×16 etc. Also, in an embodiment of this invention, depending on inter32×32geo_flag one can modify the semantics of transform_size_{—}8×8_flag. For example, if inter32×32geo_flag=1, then if transform_size_{—}8×8_flag=1 8×8 transform is in use, otherwise, if transform_size_{—}8×8_flag=0, 16×16 transform is in use.

In another embodiment of this invention, transform_size may be still modified at every macroblock despite a geometric super-macroblock mode (e.g. INTER32×32GEO) is used.

Based on the definitions and discussions here above, one skilled in the art may foresee various different implementations of residual related syntax and semantics such as CBP (the coded block pattern in the MPEG-4 AVC Standard) and/or the transform sizes, depending on whether a geometric super-macroblock mode is used. In an example of this, a new definition of CBP can be implemented at a super-macroblock level, allowing signaling of a full zero residual at a super-macroblock level using a single bit. Given the teachings of the present principles provided herein, it is to be appreciated that the preceding variation relating to CBP is but one of many implementations that may be conceived by one of ordinary skill in this and related arts, while maintaining the spirit of the present principles.

In the case when inter32×32geo_flag is equal to zero, then macroblock (2,2) is coded regularly as defined for an INTER16×16GEO macroblock. Macroblocks (2,3), (3,2), (3,3) are coded regularly and follow the pre-established definitions for all the macroblock level modes where, in an embodiment, can be those defined in TABLE 1.

In the case when a macroblock at an even-even position is not coded using an INTER16×16GEO codeword, then no inter32×32geo_flag is inserted in the data and, with respect to above example, macroblocks (2,2), (2,3), (3,2) and (3,3) are encoded separately at the macroblock level using, in an embodiment, the regular coding modes as defined in TABLE 1.

In an embodiment, an exemplary encoder would compare a coding efficiency cost of a super-macroblock INTER32×32GEO with a total coding efficiency cost of the four 16×16 macroblocks embedded in the same location of the super-macroblock, then the encoder would select the coding strategy which has the lowest cost: either INTER32×32GEO or the 4 macroblock coding modes, whichever has the lower coding cost.

TABLE 2 shows MPEG-4 Standard syntax elements for the macroblock layer. TABLE 3 shows an exemplary modified macroblock layer structure that is capable of supporting geometrically partitioned macroblocks and super-macroblocks. In an embodiment, geometric information is handled within the coding procedure mb_pred(mb_type). This exemplary modified macroblock structure presumes inter32×32geo_enable is equal to one. In an embodiment, the syntax element isMacroblockInGEOSuperMacroblock can be initialized to zero at a slice level, before each super-macroblock group is decoded.

TABLE 2

| | C | Descriptor |
|---|---|---|
| macroblock_layer( ) { | | |
| mb_type | 2 | ue(v)\|ae(v) |
| if( mb_type = = I_PCM ) { | | |
| while( !byte_aligned( ) ) | | |
| pcm_alignment_zero_bit | 2 | f(1) |
| for( i = 0; i < 256; i++ ) | | |
| pcm_sample_luma[ i ] | 2 | u(v) |
| for( i = 0; i < 2 * MbWidthC * MbHeightC; i++ ) | | |
| pcm_sample_chroma[ i ] | 2 | u(v) |
| } else { | | |
| noSubMbPartSizeLessThan8×8Flag = 1 | | |
| if( mb_type != I_N×N && | | |
| MbPartPredMode( mb_type, 0 ) != Intra_16×16 && | | |
| NumMbPart( mb_type ) = = 4 ) { | | |
| sub_mb_pred( mb_type ) | 2 | |
| for( mbPartIdx = 0; mbPartIdx < 4; mbPartIdx++ ) | | |
| if( sub_mb_type[ mbPartIdx ] != B_Direct_8×8 ) { | | |
| if( NumSubMbPart( sub_mb_type[ mbPartIdx ] ) > 1 ) | | |
| noSubMbPartSizeLessThan8×8Flag = 0 | | |
| } else if( !direct_8×8_inference_flag ) | | |
| noSubMbPartSizeLessThan8×8Flag = 0 | | |
| } else { | | |
| if( transform_8×8_mode_flag && mb_type = = I_N×N ) | | |
| transform_size_8×8_flag | 2 | u(1)\|ae(v) |
| mb_pred( mb_type ) | 2 | |
| } | | |
| if( MbPartPredMode( mb_type, 0 ) != Intra_16×16 ) { | | |
| coded_block_pattern | 2 | me(v)\|ae(v) |
| if( CodedBlockPatternLuma > 0 && | | |
| transform_8×8_mode_flag && mb_type != I_N×N && | | |
| noSubMbPartSizeLessThan8×8Flag && | | |
| ( mb_type != B_Direct_16×16 \|\| direct_8×8_inference_flag ) ) | | |
| transform_size_8×8_flag | 2 | u(1)\|ae(v) |
| } | | |
| if( CodedBlockPatternLuma > 0 \|\| CodedBlockPatternChroma > 0 \|\| | | |
| MbPartPredMode( mb_type, 0 ) = = Intra_16×16 ) { | | |
| mb_qp_delta | 2 | se(v)\|ae(v) |
| residual( ) | 3\|4 | |
| } | | |
| } | | |
| } | | |

TABLE 3

| | C | Descriptor |
|---|---|---|
| macroblock_layer( ) { | | |
| MBpositionX= CurrMbAddr%PicWidthInMbs | | |
| MBpositionY= floor(CurrMbAddr/PicWidthInMbs) | | |
| if(isMacroblockInGEOSuperMacroblok==0 \|\| (MBpositionX%2==0 && MBpositionX%2==0)){ | | |
| mb_type | 2 | ue(v)\|ae(v) |
| if(mb_type==INTER16×16GEO){ | | |
| inter32×32geo_flag | 2 | f(1) |
| isMacroblockInGEOSuperMacroblok= inter32 ×32geo_flag | | |
| }else{ | | |
| isMacroblockInGEOSuperMacroblok=0 | | |
| } | | |
| } | | |
| if( mb_type = = I_PCM ) { | | |
| while( !byte_aligned( ) ) | | |
| pcm_alignment_zero_bit | 2 | f(1) |
| for( i = 0; i < 256; i++ ) | | |
| pcm_sample_luma[ i ] | 2 | u(v) |
| for( i = 0; i < 2 * MbWidthC * MbHeightC; i++ ) | | |
| pcm_sample_chroma[ i ] | 2 | u(v) |
| } else { | | |
| noSubMbPartSizeLessThan8×8Flag = 1 | | |
| if( mb_type != I_N×N && | | |
| MbPartPredMode( mb_type, 0 ) != Intra_16×16 && | | |
| NumMbPart( mb_type ) = = 4 ) { | | |
| sub_mb_pred( mb_type ) | 2 | |
| for( mbPartIdx = 0; mbPartIdx < 4; mbPartIdx++ ) | | |
| if( sub_mb_type[ mbPartIdx ] != B_Direct_8×8 ) { | | |
| if( NumSubMbPart( sub_mb_type[ mbPartIdx ] ) > 1 ) | | |
| noSubMbPartSizeLessThan8×8Flag = 0 | | |
| } else if( !direct_8×8_inference_flag ) | | |
| noSubMbPartSizeLessThan8×8Flag = 0 | | |
| } else { | | |
| if( transform_8×8_mode_flag && mb_type = = I_N×N ) | | |
| transform_size_8×8_flag | 2 | u(1)\|ae(v) |
| if(isMacroblockInGEOSuperMacroblok==0 \|\| (MBpositionX%2==0 && | | |
| MBpositionY%2==0)){ | | |
| mb_pred( mb_type ) | 2 | |
| } | | |
| } | | |
| if( MbPartPredMode( mb_type, 0 ) != Intra_16×16 ) { | | |
| coded_block_pattern | 2 | me(v)\|ae(v) |
| if( CodedBlockPatternLuma > 0 && | | |
| transform_8×8_mode_flag && mb_type != I_N×N && | | |
| noSubMbPartSizeLessThan8×8Flag && | | |
| ( mb_type != B_Direct_16×16 \|\| direct_8×8_inference_flag ) ) | | |
| transform_size_8×8_flag | 2 | u(1)\|ae(v) |
| } | | |
| if( CodedBlockPatternLuma > 0 \|\| CodedBlockPatternChroma > 0 \|\| | | |
| MbPartpredMode( mb_type, 0 ) = = Intra_16×16 ) { | | |
| mb_qp_delta | 2 | se(v)\|ae(v) |
| residual( ) | 3\|4 | |
| } | | |
| } | | |
| } | | |

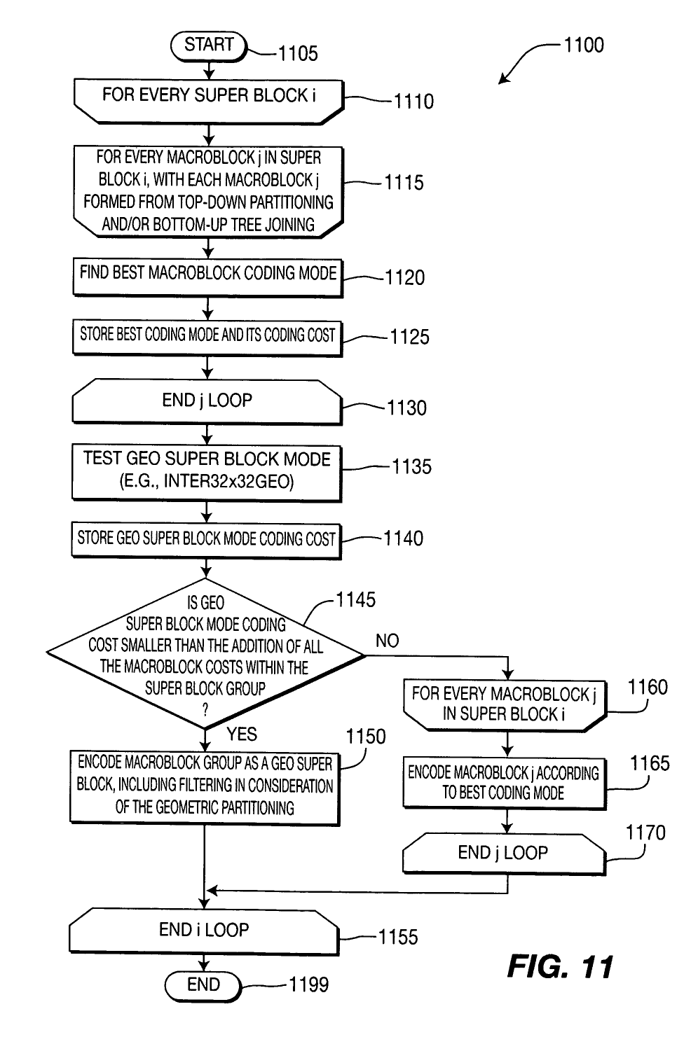

Turning to FIG. 11, an exemplary method for video encoding is indicated generally by the reference numeral 1100. The method 1100 combines geometry-adaptive partitions on super-macroblocks with macroblock sized coding modes.

The method 1100 includes a start block 1105 that passes control to a loop limit block 1110. The loop limit block 1110 begins a loop for every super block i, and passes control to a loop limit block 1115. The loop limit block 1115 begins a loop for every macroblock j in super block i, and passes control to a function block 1120. The function block 1120 finds the best macroblock coding mode, and passes control to a function block 1125. The function block 1125 stores the best coding mode and its coding cost, and passes control to a loop limit block 1130. The loop limit block 1130 ends the loop for every macroblock j in super block i, and passes control to a function block 1135. The function block 1135 tests GEO super block mode (e.g., INTER32×32GEO), and passes control to a function block 1140. The function block 1140 stores the GEO super block mode coding cost, and passes control to a decision block 1145. The decision block 1145 determines whether or not the GEO super block mode coding cost is smaller than the addition of all the macroblock costs within the super block group. If so, then control is passed to a function block 1150. Otherwise, control is passed to a loop limit block 1160.

The function block 1150 encodes the super block group as a GEO super block, and passes control to a loop limit block 1155. The loop limit block 1155 ends the loop for every super block i, and passes control to an end block 1199.

The loop limit block 1160 begins a loop for every macroblock j in super block i, and passes control to a function block 1165. The function block 1165 encodes the current macroblock j according to the best coding mode, and passes control to a loop limit block 1170. The loop limit block 1170 ends the loop for every macroblock j in super block i, and passes control to the loop limit block 1155.

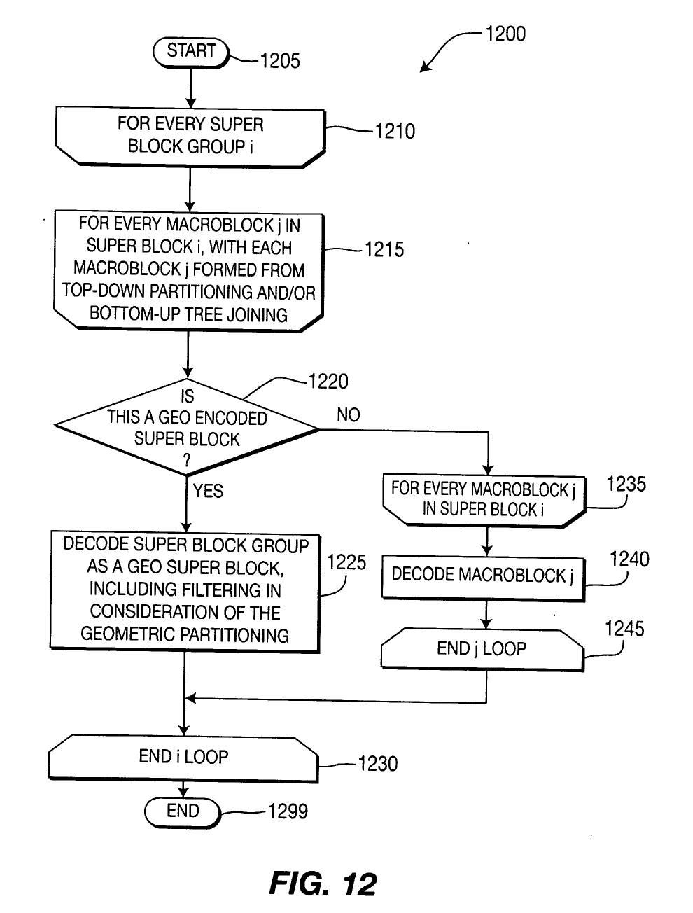

Turning to FIG. 12, an exemplary method for video decoding is indicated generally by the reference numeral 1200. The method 1200 combines geometry-adaptive partitions on super-macroblocks with macroblock sized coding modes.

The method 1200 includes a start block 1205 that passes control to a loop limit block 1210. The loop limit block 1210 begins a loop for every super block group i, and passes control to a loop limit block 1215. The loop limit block 1215 begins a loop for every macroblock j in super block group i, and passes control to a decision block 1220. The decision block 1220 determines whether or not this is a GEO encoded super block. If so, the control is passed to a function block 1125. Otherwise, control is passed to a loop limit block 1235.

The function block 1125 decodes the super block group as a GEO super block, and passes control to a loop limit block 1230. The loop limit block 1230 ends the loop for every super block i, and passes control to an end block 1199.

The loop limit block 1235 begins a loop for every macroblock j in super block i, and passes control to a function block 1240. The function block 1240 decodes the current macroblock j, and passes control to a loop limit block 1245. The loop limit block 1245 ends the loop for every macroblock j in super block i, and passes control to the loop limit block 1230.

A description will now be given of some of the many attendant advantages/features of the present invention, some of which have been mentioned above. For example, one advantage/feature is an apparatus having an encoder for encoding image data for at least a portion of a picture. The image data is formed by a geometric partitioning that applies geometric partitions to picture block partitions. The picture block partitions are obtained from at least one of top-down partitioning and bottom-up tree joining.

Another advantage/feature is the apparatus having the encoder as described above, wherein the geometric partitioning is enabled for use at partition sizes larger than a base partitioning size of a given video coding standard or video coding recommendation used to encode the image data.

Yet another advantage/feature is the apparatus having the encoder as described above, wherein the encoder combines at least one of the geometric partitions having a partition size larger than the base partitioning size with a base partition having the base partitioning size. The base partition corresponds to at least a portion of at least one of the picture block partitions.

Still another advantage/feature is the apparatus having the encoder as described above, wherein the encoder at least one of implicitly codes and explicitly codes at least one of edge information and motion information for the portion.

Moreover, another advantage/feature is the apparatus having the encoder as described above, wherein a residue corresponding to at least the portion is coded using at least one variable size transform that is permitted to cross partition boundaries.

Further, another advantage/feature is the apparatus having the encoder as described above, further comprising a deblocking filter for performing deblocking filtering in consideration of the geometric partitioning.

Also, another advantage/feature is the apparatus having the encoder as described above, wherein the encoder signals a use of the geometric partitions at least one of a high level syntax level, a sequence level, a picture level, a slice level, and a block level.

Additionally, another advantage/feature is the apparatus having the encoder as described above, wherein the encoder signals local super block related information for at least one of the picture block partitions using at least one of implicit data and explicit data.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding image data for at least a portion of a picture, wherein the image data is formed by a geometric partitioning that applies geometric partitions to picture block partitions, the picture block partitions obtained from at least one of top-down partitioning and bottom-up tree joining.

2. The apparatus of claim 1, wherein the geometric partitioning is enabled for use at partition sizes larger than a base partitioning size of a given video coding standard or video coding recommendation used to encode the image data.

3. The apparatus of claim 1, wherein said encoder combines at least one of the geometric partitions having a partition size larger than the base partitioning size with a base partition having the base partitioning size, the base partition corresponding to at least a portion of at least one of the picture block partitions.

4. The apparatus of claim 1, wherein said encoder at least one of implicitly codes and explicitly codes at least one of edge information and motion information for the portion.

5. The apparatus of claim 1, wherein a residue corresponding to at least the portion is coded using at least one variable size transform that is permitted to cross partition boundaries.

6. The apparatus of claim 1, further comprising a deblocking filter for performing deblocking filtering in consideration of the geometric partitioning.

7. The apparatus of claim 1, wherein said encoder signals a use of the geometric partitions at least one of a high level syntax level, a sequence level, a picture level, a slice level, and a block level.

8. The apparatus of claim 1, wherein said encoder signals local super block related information for at least one of the picture block partitions using at least one of implicit data and explicit data.

9. A method, comprising:
encoding image data for at least a portion of a picture, wherein the image data is formed by a geometric partitioning that applies geometric partitions to picture block partitions, the picture block partitions obtained from at least one of top-down partitioning and bottom-up tree joining.

10. The method of claim 9, wherein the geometric partitioning is enabled for use at partition sizes larger than a base partitioning size of a given video coding standard or video coding recommendation used to encode the image data.

11. The method of claim 10, wherein said encoding step comprises combining at least one of the geometric partitions having a partition size larger than the base partitioning size with a base partition having the base partitioning size, the base partition corresponding to at least a portion of at least one of the picture block partitions.

12. The method of claim 9, wherein at least one of edge information and motion information for the portion is at least one of implicitly coded and explicitly coded.

13. The method of claim 9, wherein a residue corresponding to at least the portion is coded using at least one variable size transform that is permitted to cross partition boundaries.

14. The method of claim 9, further comprising performing deblocking filtering in consideration of the geometric partitioning.

15. The method of claim 9, further comprising signaling a use of the geometric partitions at least one of a high level syntax level, a sequence level, a picture level, a slice level, and a block level.

16. The method of claim 9, further comprising signaling local super block related information for at least one of the picture block partitions using at least one of implicit data and explicit data.

17. An apparatus, comprising:
a decoder for decoding image data for at least a portion of a picture, wherein the image data is formed by a geometric partitioning that applies geometric partitions to picture block partitions, the picture block partitions obtained from at least one of top-down partitioning and bottom-up tree joining.

18. The apparatus of claim 17, wherein the geometric partitioning is enabled for use at partition sizes larger than a base partitioning size of a given video coding standard or video coding recommendation used to decode the image data.

19. The apparatus of claim 18, wherein said decoder combines at least one of the geometric partitions having a partition size larger than the base partitioning size with a base partition having the base partitioning size, the base partition corresponding to at least a portion of at least one of the picture block partitions.

20. The apparatus of claim 17, wherein said decoder at least one of implicitly decodes and explicitly decodes at least one of edge information and motion information for the portion.

21. The apparatus of claim 17, wherein a residue corresponding to at least the portion is decoded using at least one variable size transform that is permitted to cross partition boundaries.

22. The apparatus of claim 17, further comprising a deblocking filter for performing deblocking filtering in consideration of the geometric partitioning.

23. The apparatus of claim 17, wherein said decoder determines a use of the geometric partitions from at least one of a high level syntax level, a sequence level, a picture level, a slice level, and a block level.

24. The apparatus of claim 17, wherein said decoder signals local super block related information for at least one of the picture block partitions using at least one of implicit data and explicit data.

25. A method, comprising:
decoding image data for at least a portion of a picture, wherein the image data is formed by a geometric partitioning that applies geometric partitions to picture block partitions, the picture block partitions obtained from at least one of top-down partitioning and bottom-up tree joining.

26. The method of claim 25, wherein the geometric partitioning is enabled for use at partition sizes larger than a base partitioning size of a given video coding standard or video coding recommendation used to encode the image data.

27. The method of claim 26, wherein said decoding step comprises combining at least one of the geometric partitions having a partition size larger than the base partitioning size with a base partition having the base partitioning size, the base partition corresponding to at least a portion of at least one of the picture block partitions.

28. The method of claim 25, wherein at least one of edge information and motion information for the portion is at least one of implicitly decoded and explicitly decoded.

29. The method of claim 25, wherein a residue corresponding to at least the portion is coded using at least one variable size transform that is permitted to cross partition boundaries.

30. The method of claim 25, further comprising performing deblocking filtering in consideration of the geometric partitioning.

31. The method of claim 25, further comprising determining a use of the geometric partitions from at least one of a high level syntax level, a sequence level, a picture level, a slice level, and a block level.

32. The method of claim 25, further comprising determining local super block related information for at least one of the picture block partitions from at least one of implicit data and explicit data.

33. A video signal structure for video encoding, comprising:
image data encoded for at least a portion of a picture, wherein the image data is formed by a geometric partitioning that applies geometric partitions to picture block partitions, the picture block partitions obtained from at least one of top-down partitioning and bottom-up tree joining.
